(19) United States
(12) Patent Application Publication
(10) Pub. No.: US 2011/0076083 A1
(43) Pub. Date: Mar. 31, 2011

(54) RECORDING MEDIUM SUPPORT APPARATUS AND RECORDING APPARATUS

(75) Inventors: Norio Tsurui, Kawasaki-shi (JP); Ryoya Shinjo, Kawasaki-shi (JP); Masahiro Koshikawa, Kawasaki-shi (JP)

(73) Assignee: CANON KABUSHIKI KAISHA, Tokyo (JP)

(21) Appl. No.: 12/890,297

(22) Filed: Sep. 24, 2010

(30) Foreign Application Priority Data
Sep. 29, 2009 (JP) 2009-224829

(51) Int. Cl. B41J 15/02; B65H 20/00

(52) U.S. Cl. 400/611; 226/152

(57) ABSTRACT

A support apparatus to support a roll-shaped recording medium with a simple configuration and to enhance a conveyance performance. A recording medium support apparatus for supporting a recording medium rolled around a core tube includes a first fitting portion to be fitted to a first end portion of the core tube, a second fitting portion to be fitted to a second end portion of the core tube, a first rotation shaft to be supported by the first fitting portion via bearings such that the first rotation shaft can be rotated with respect to the first fitting portion, a second rotation shaft to be supported by the second fitting portion via bearings such that the second rotation shaft can be rotated with respect to the second fitting portion, and a supporting unit to support the first and second rotation shafts.

### BACKGROUND OF THE INVENTION

1. Field of the Invention

The present invention relates to a recording medium support apparatus that supports a roll-shaped recording medium at both end portions thereof and a recording apparatus including the recording medium support apparatus.

2. Description of the Related Art

Examples of a recording apparatus that records an image on a recording medium based on image information include a printer, a copying machine, a facsimile machine, and the like. Further, examples of the recording apparatus includes a multifunction peripheral including other functions such as a printer function, a facsimile function, a document reading function, and an image capturing function and a system device including the recording apparatus connected to a host device such as a computer. An exemplary recording apparatus used in these apparatuses uses a recording medium in a state that a sheet, e.g., a recording medium or a film, is rolled up (hereinafter referred to as the “roll sheet”). The above described recording apparatus uses a sheet conveyance apparatus for feeding and conveying a sheet from a roll sheet holding unit which holds a roll sheet to an image formation area. The “sheet” in the present invention refers to a recording medium. A material of the “sheet” is not limited to paper or a plastic sheet.

In a configuration of a conventional roll sheet holding unit, a long shaft (which is referred to as the “spool shaft”) which includes flanges at both end portions thereof is passed through a center of the roll sheet and the flanges and rotationally supported by bearing units of a main body of the roll sheet holding unit. One of the flanges is configured so as to be slidable over the spool shaft according to a width of the roll sheet.

However, the above described configuration requires a longer spool shaft as the roll sheet width becomes wider and a wider working space when the spool shaft is inserted into the roll sheet. Therefore, workability is not so good in the above described configuration. Further, a hollow iron tube or a hollow aluminum tube is typically used as a material of the spool shaft when a weight of the roll sheet is taken into consideration. However, as the spool shaft becomes longer, not only a cost of the spool shaft becomes higher but also a weight of the spool shaft becomes heavier. Accordingly, the workability becomes worse.

For the purpose of resolving the above described issue, Japanese Patent Application Laid-open No. 11-322141 and No. 2007-261754 discuss a configuration of a roll holder without the spool shaft.

However, the apparatus discussed in Japanese Patent Application Laid-open No. 11-322141 has a configuration that flange members fit to a core tube of the roller sheet are only suspended on the bearing units of the main body, so that the flanges tend to tilt due to a weight of the roll sheet. If the flanges tilt, a rotational center of the roll sheet may be shifted to cause a skew feeding of the roll sheet.

The apparatus discussed in Japanese Patent Application Laid-open No. 2007-261754 has a configuration that the flange members are rotatably supported by the main body of the apparatus and the bearing of one of the flanges is slidably supported in a width direction of the roll sheet such that a width of the bearing is adjusted to a width of the roll sheet. In Japanese Patent Application Laid-open No. 2007-261754, the issue of tilting flanges is somewhat relieved. However, when the roll sheet is installed to the apparatus, while the core tube of the roll sheet is fit to one of the flange members, the other one of the flange members is slid to be fit to the core tube. With the configuration of Japanese Patent Application Laid-open No. 2007-261754, when the roll sheet is exchanged, the other one of the flange members is required to be moved in the width direction (i.e., in an opening direction), even in a case where a width of the roll sheet is not changed.

### SUMMARY OF THE INVENTION

The present invention is directed to a recording medium support apparatus capable of reducing a rotational resistance of a roll sheet and improving a working efficiency in installing the roll sheet, and a recording apparatus which includes the recording medium support apparatus.

According to an aspect of the present invention, a record medium support apparatus for supporting a recording medium which is rolled into a roll shape around a core tube includes a first fitting portion configured to be fitted to a first end portion of the core tube, a second fitting portion configured to be fitted to a second end portion of the core tube, a first rotation shaft configured to be supported by the first fitting portion via bearings such that the first rotation shaft can be rotated with respect to the first fitting portion, a second rotation shaft configured to be supported by the second fitting portion via bearings such that the second rotation shaft can be rotated with respect to the second fitting portion, and a supporting unit configured to support the first rotation shaft and the second rotation shaft.

According to the present invention, a recording medium support apparatus capable of reducing a rotational resistance of a roll sheet and improving a working efficiency in installing the roll sheet, and a recording apparatus including the recording medium support apparatus can be provided.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a cross sectional view illustrating an exemplary embodiment of an image recording apparatus.

FIG. 2 is a perspective view of a roll sheet conveyance apparatus.

FIG. 3 illustrates a schematic configuration of the roll sheet conveyance apparatus.

FIG. 4 is across sectional view of a roll holder unit.

FIG. 5 illustrates a leaf spring.

FIG. 6 illustrates a driving force transmission mechanism of the roll sheet.

FIG. 7 is a perspective view of a roll holder locking unit.

FIG. 8 is a side view illustrating an OFF state (i.e., a free state) of a lock lever.

FIG. 9 is a side view illustrating an ON state (i.e., a lock state) of the lock lever.

### DESCRIPTION OF THE EMBODIMENTS

Various exemplary embodiments, features, and aspects of the invention will be described in detail below with reference to the drawings.

Now, a recording medium support apparatus according to an exemplary embodiment of the present invention is described below with reference to drawings attached hereto.

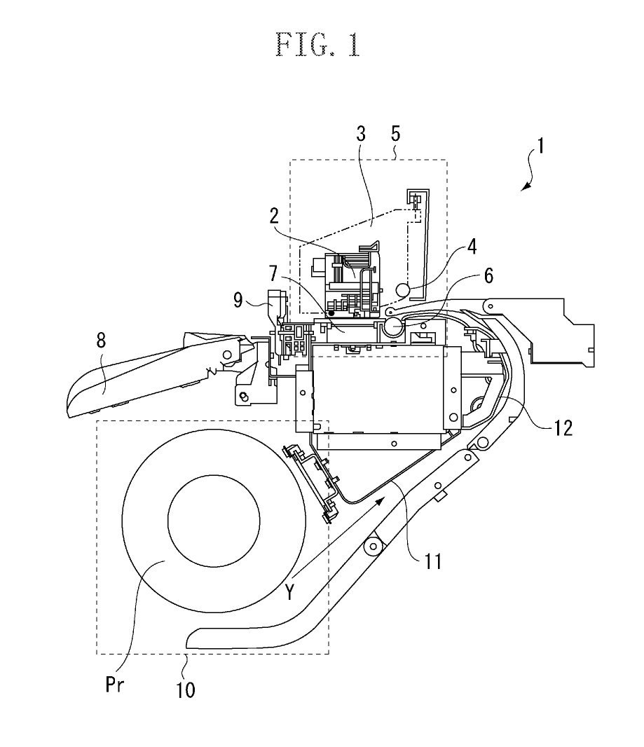

FIG. 1 is a cross sectional view illustrating the exemplary embodiment of a recording apparatus which includes the recording medium support apparatus. A series of operations on a recording medium that is fed to an image recording apparatus 1 and cut by a cutting unit is described below with reference to FIG. 1.

In FIG. 1, a carriage 3 in which a recording head 2 as a recoding means of a recording unit 5 is installed is supported by a main rail 4 as a scanning guide provided to the image recording apparatus 1. The carriage 3 is reciprocatably guided by the main rail 4. A recording medium Pr is rolled into a roll shape and held by a roll sheet feed unit 10. When a worker feeds the recording medium to the recording unit 5, the worker withdraws the roll shaped recording medium Pr (i.e., the roll sheet) from the roll sheet feed unit 10 such that the recording medium is withdrawn along a pair of sheet feed guides 11 and 12 and inserted into the recording unit 5 in a sheet conveyance direction (i.e., in a Y direction). Then, the recording medium is nipped between an LF roller 6 and a pinch roller to be further conveyed. The roll sheet Pr includes a recording medium made of recording paper or a plastic sheet formed into a continuous roll shape. That is, a material of the roll sheet Pr is not limited to paper.

The roll sheet Pr is conveyed by the LF roller 6 that is positioned at an upstream side of the recording unit 5 as a conveyance unit. The recording unit 5 is provided with a platen 7 for supporting the recording medium from a rear surface side of the recording medium. The platen 7 is configured to guide the recording medium such that a gap is formed between a recording surface of the recording medium and the recording head 2.

The recording head 2 is configured to record an image while the recording head 2 is moving along the main rail 4. At every time the recording head 2 moves in a forward direction or in a backward direction along the main rail 4 to record an image corresponding to a single line, the recording medium is conveyed in a conveyance direction by the LF roller 6 by a predetermined pitch. While the recording medium is conveyed by the predetermined pitch, the recording head 2 is moved again to record an image of the next line. Repetition of the above described processing enables recording of the image of the entire page. A recorded portion of the recording medium is conveyed toward an outside of a sheet discharge guide 8.

The recording medium is conveyed to a predetermined cutting position by the LF roller 6 after the recording of the image is completed. Then, the recording medium after the recording operation is cut by a cutter unit 9 according to a signal for a cutting operation.

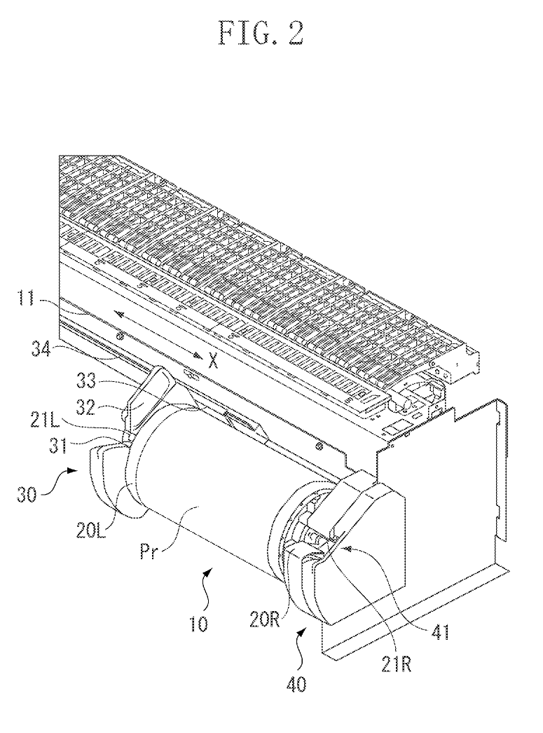

Now, a roll sheet conveyance apparatus 10 according to the present exemplary embodiment of the present invention is described below with reference to FIGS. 2 through 6.

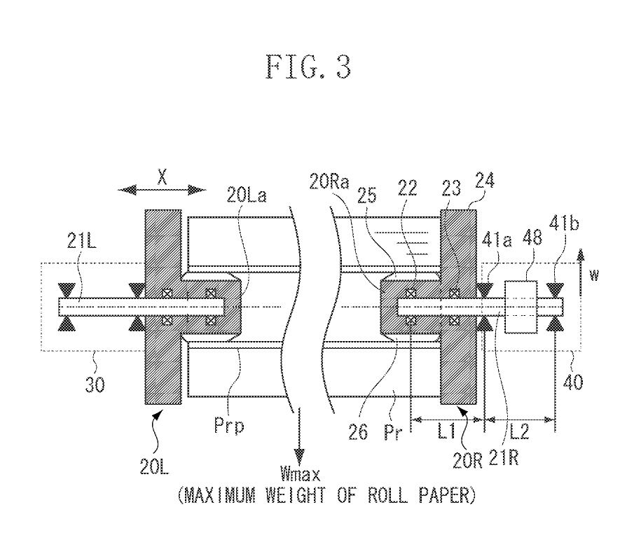

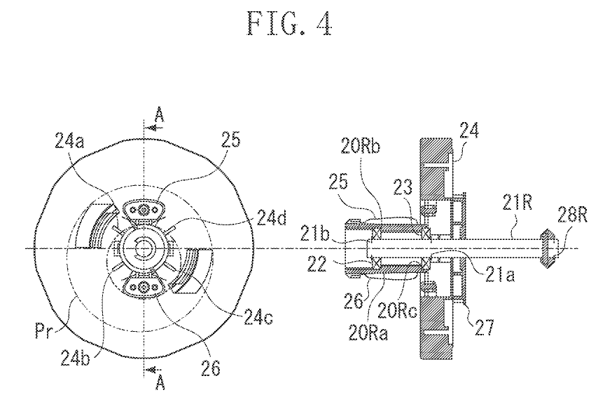

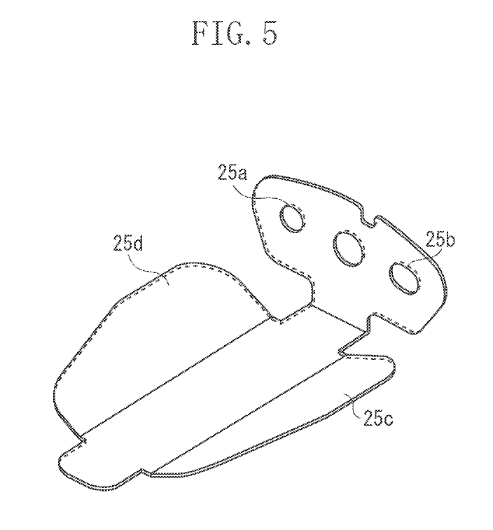

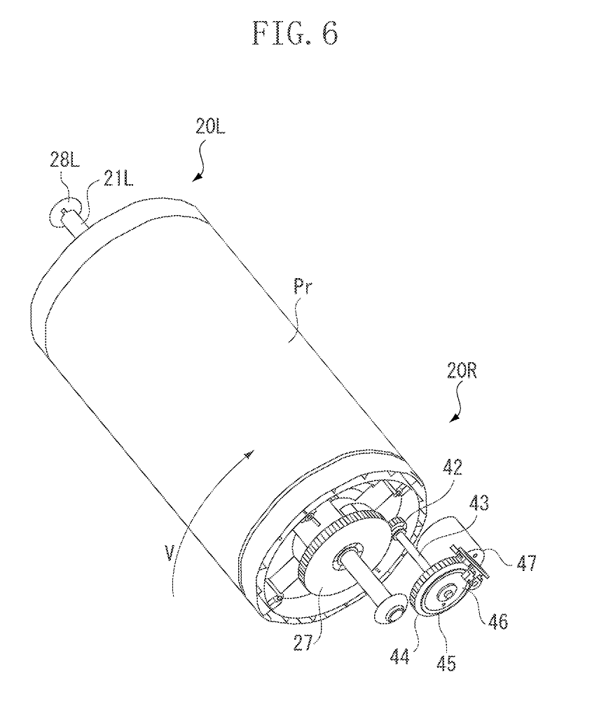

FIG. 2 is a perspective view of the roll sheet conveyance apparatus. FIG. 3 illustrates a schematic configuration of the roll sheet conveyance apparatus. FIG. 4 is a cross sectional view of the roll holder unit. FIG. 5 illustrates a leaf spring. FIG. 6 illustrates a driving force transmission mechanism of the roll sheet.

A pair of roll holders 20R and 20L for supporting both end portions of the roll sheet Pr includes fitting portions 20Ra and 20La, respectively. Each of the fitting portions 20Ra and 20La has a shaft shape. The fitting portion to be fitted into a first end portion of a core tube is referred to as a first fitting portion 20Ra in some cases, whereas the fitting portion 20La to be fitted into a second end portion of the core tube is referred to as a second fitting portion in some cases. Insertion of the fitting portions 20Ra and 20La into the corresponding end portions of the core tube Prp of the roll sheet Pr enables the fitting portions 20Ra and 20La to fit into the core tube Prp.

The roll holders 20R and 20L include flanges 24, respectively. When the fitting portions 20Ra and 20La are fitted into the corresponding end portions of the core tube Prp, respectively, each of the flanges 24 contacts or faces the corresponding end portion of the roll sheet Pr. The roll holders 20R and 20L include rotational rotation shafts 21R and 21L, respectively. The rotation shafts 21R and 21L protrude from the fitting portions 20Ra and 20La, respectively. The fitting portions 20Ra and 20La protrude from one of sides of the flanges 24, respectively. The rotation shafts 21R and 21L protrude from the other sides of the flanges 24, respectively. The rotation shaft 21R provided to the first fitting portion 20Ra is referred to as a first rotation shaft in some cases, whereas the rotation shaft 21L provided to the second fitting portion 20La is referred to as a second rotation shaft in some cases.

The rotation shafts 21R and 21L are installed to be supported by a slider unit 30 and a bearing unit 40 illustrated in FIG. 2, so that the roll sheet Pr is rotatably suspended with respect to the main body. A configuration of the roll holder 20R is identical to that of the roll holder 20L. Therefore, no left-to-right error occurs in inserting the roller holders 20R and 20L.

The roll holder 20R is supported at two positions by the rotation shaft 21R via bearings 22 and 23 for receiving the roll holder 20R. The bearings 22 and 23 may be resin-made bearings or ball bearings. Since the roll holder 20L has the same configuration as the roll holder 20R, the configurations thereof are described below based on the roller holder 20R.

The roll holder 20R is rotatable with respect to the rotation shaft 21R without a backlash therebetween. The fitting portion 20Ra of the roll holder 20R has a cylindrical shape and provided with the bearings 22 and 23 on an inner side thereof. The bearings 22 and 23 are fixed to the rotation shaft 21R in an axial direction (i.e., in a thrust direction) by using steps 20Rb and 20Rc formed on an inner circumferential surface of the fitting portion 20Ra and snap rings 21a and 21b fit to the rotation shaft 21R.

By supporting of the roll holder 20R onto the rotation shaft 21R using the two bearings 22 and 23 which are distantly-positioned in the axial direction, a rotational center of the roll holder 20R can be prevented from tilting with respect to the rotation shaft 21R due to a moment force generated from a weight of the roll sheet Pr. The rotation shaft 21R is held tight by below described bearing units of the main body and thus this configuration contributes reduction of tilting of the roll holder 20R.

Since absence of the backlash of the roll holder 20R with respect to the rotation shaft 21R can improve alignment accuracy while preventing occurrence of a rotation loss (i.e., a variable rotation), a constant stable sheet conveyance can be realized, regardless of a weight or a conveyance speed of the roll sheet Pr. More economical configurations can be realized by using slide bearings or flange bearing units instead of using the ball bearings. However, with the slide bearings or the flange bearing units, a predetermined clearance and the rotation loss due to occurrence of a slide resistance caused by the weight of the roll sheet Pr may be generated. Therefore, it is desirable to determine the bearings in view of a conveyance performance and a specification of the roll sheet Pr to be required.

The fitting portion 20Ra is provided with a plurality of ribs 24a, 24b, 24c, and 24d. The ribs 24a, 24b, 24c, and 24d are radially equiangularly arranged so as to contact an inner diameter φd of the core tube Prp of the roll sheet Pr. Leaf springs 25 and 26 are fixed to the flange 24 in such a manner that the leaf springs 25 and 26 as spring members radiate out from the fitting portion 20Ra to be pushed against the inner circumferential surface of the core tube Prp. FIG. 5 illustrates the leaf spring 25. The leaf spring 25 (having the same shape as the leaf spring 26) is fixed to the flange 24 with screws through screw holes 25a and 25b. Blade portions 25c and 25d of the leaf spring 25 are extending radially from the fitting portion 20Ra. The fitting portion 20Ra inserted into the core tube Prp is fixed by these ribs 24a, 24b, 24c, and 24d and the leaf springs 25 and 26 in a rotational direction and a thrust direction.

Since the leaf springs 25 and 26 which are pushed against the inner circumferential surface of the core tube Prp are provided to the flange 24, even if the inner diameter of the roll sheet Pr varies, the variation of the inner diameter is absorbed by the leaf springs 25 and 26. Further, because edges of the leaf springs bite into the core tube Prp, better gripping can be realized. Still further, the leaf springs 25 and 26 are arranged along a line in an inserting and withdrawing direction, so that not a large operability is required.

A roll gear 27 is installed to the flange 24 formed on the roll holder 20R. Rotation of the roll sheet Pr is controlled by a below described roll driving unit via the roll gear 27. Since the roll gear 27 is directly installed to the flange 24 for holding the roll sheet Pr, a transmission loss can be reduced and rotation control can be efficiently performed. Further, the roll gear 27 can directly rotatably drive the flange 24 and can efficiently control the rotation while reducing a backlash or the like.

Ends of the rotation shafts 21R and 21L are provided with movable rollers 28R and 28L, respectively, for restricting a movement of the roll sheet Pr in the thrust direction. The movable rollers 28R and 28L, the roll gear 27 and a below described pair of guide slopes 41 and 31 perform positioning of the roll sheet Pr in a sheet width direction.

The installation of the roll sheet Pr into the main body of the apparatus is performed such that the rotation shaft 21R of the roll holder 20R and the rotation shaft 21L of the roll holder 20L are dropped into the guide slope 41 of the bearing unit 40 and the guide slope 31 of the slider unit 30, respectively. The guide slopes 41 and 31 are supporting units of the main body side. The guide slopes 41 and 31 are formed into U-shaped grooves. The rotation shaft 21R and the rotation shaft 21L respectively roll along the guide slope 41 and the guide slope 31 to bottoms of the U-shaped grooves, i.e., at contact portions of the guide slopes 41 and 31. Thus, setting of the roll sheet Pr is completed. Since the rotation shafts 21R and 21L are rotatable with respect to the roll sheet Pr, the rotation shafts 21R and 21L are installed while they are smoothly rolling on the guide slope 41 and the guide slope 31, respectively, regardless of the weight of the roll sheet Pr.

At the same time of the setting, the rotation shaft 21R is automatically locked, of which mechanism is described below.

The slider unit 30 includes a slider sliding unit 33. The slider sliding unit 33 can freely slide in a sheet width direction X on a slide rail 34 mounted to the sheet feed guide 11. When a worker installs the roll sheet Pr, the worker grips a slider grip 32 to move the slider unit 30 to a position according to a sheet width of the roll sheet Pr. The slider unit 30 and the roll holder 20L are provided with a predetermined thrust backlash (e.g., 10 mm in the present exemplary embodiment) in the sheet width direction. Since the positioning of the roll sheet Pr in the sheet direction is performed at the side of the roll holder 20R as described above, it is not necessary to set the slider unit 30 at an accurate position.

When the roll holder 20R is set to the bearing unit 40 of the main body, the roll gear 27 is connected to an input gear 42. The input gear 42 is coupled with an idler gear 44 via a gear shaft 43. The idler gear 44 engages with a gear of the driving motor 47. The roll gear 27, the input gear 42 and the idler gear 44 form a rotation transmission unit for transmitting a driving force from the motor 47 to the flange 24. The idler gear 44 is provided with an encoder film 45 so as to be attached thereto. The idler gear 44 is further provided with an encoder sensor 46 for reading the encoder film 45. The driving motor 47 is a direct current (DC) motor which performs control based on a signal of the encoder sensor 46.

The driving motor 47 mainly performs an operation of a case (1) an application of no-load (i.e., turning OFF of excitation) upon setting a sheet, a case (2) excitation by a predetermined force upon conveying a sheet in a forward direction, a case (3) reverse driving of the roll sheet Pr upon rewinding the roll sheet Pr. In the case (2), the excitation by the predetermined force upon conveying a sheet in the forward direction is referred to as a back tension of the roll. More specifically, an acting force generated in a direction opposite to a conveyance force of the LF roller 6 can be used to correct skew feeding or to remove slack of the sheet upon setting the sheet, so that highly accurate sheet conveyance can be realized. It is desirable that the acting force is set to an appropriate value in view of a size or a physical property of the roll. In the present exemplary embodiment, the acting force is set to 9.8 Ncm (1 kgfcm) on the shaft of the roll sheet Pr.

In the case (3), a rotation speed Vb at the time of rewinding the roll sheet Pr is set to a value larger than a speed V when the LF roller 6 conveys the roll sheet. However, since a driving torque of the roll sheet Pr is set to a value smaller than a torque of the driving unit (not shown) of the LF roller 6, the sheet is rolled at the same speed while the sheet is applied with a predetermined tension (e.g., the 9.8 Ncm in the present exemplary embodiment).

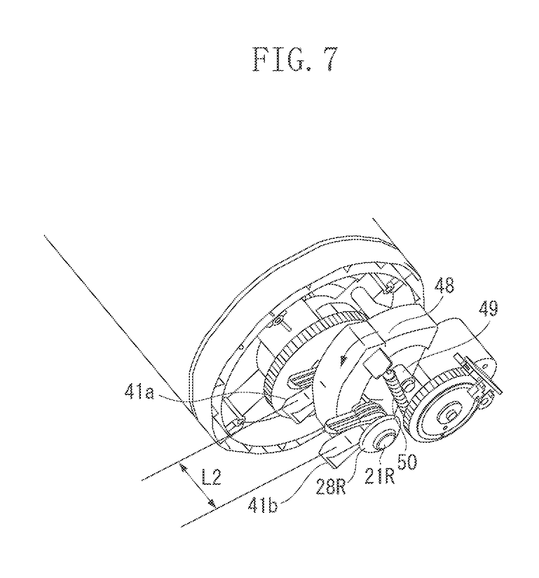

Now, a locking mechanism is described below with reference to FIGS. 7 through 9.

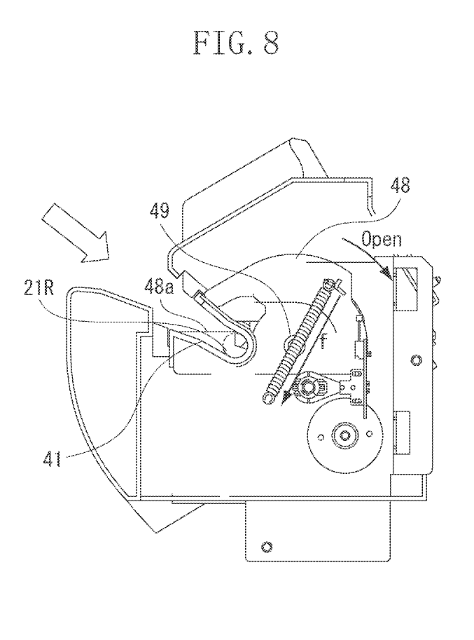

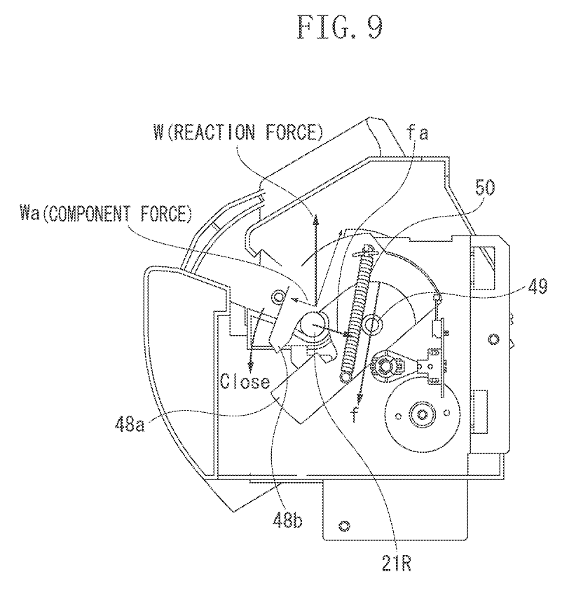

FIG. 7 is a perspective view of a roll holder locking unit. FIG. 8 is a side view of a lock lever illustrating a state that the lock lever is turned OFF (i.e., in a free state). FIG. 9 is a side view of the lock lever illustrating a state that the lock lever is turned ON (i.e., in a lock state).

Retainment of the rotation shaft 21R in the U-shaped fitting portions 41a and 41b of the guide slope 41 enables positioning of the roll holder 20R.

A lock lever 48 as a locking member rotatably supported by a lever shaft 49 is provided between the U-shaped fitting portions 41a and 41b. The lock lever 48 is pushed with an acting force f (e.g., 9.8 N in the present exemplary embodiment) by a lever spring 50 (i.e., a spring). The lock lever 48 has two stable positions according to acting directions of the lever shaft 49 which is a rotation center thereof and the lever spring 50 (i.e., bi-stable spring). In other words, the lock lever 48 can be moved between a restricted position at which the rotation shaft 21R is set in a state engaged with the U-shaped grooves of the U-shaped fitting portions 41a and 41b and an open position at which the rotation shaft 21R is brought to be free from the U-shaped grooves of the U-shaped fitting portions 41a and 41b. When the lock lever 48 is in the restricted position, the lever spring 50 pushes the lock lever 48 toward a direction to maintain the lock lever 48 in the restricted position. When the lock lever 48 is in the open position, the lever spring 50 pushes the lock lever 48 toward a direction to maintain the lock lever 48 in the open position.

Since the rotation shafts 21R and 21L as the rotational centers and the roll sheet Pr are rotationally held by the flanges 24, locking of the rotation shafts 21R and 21L at a side of the main body can prevent the flanges 24 to be tilted due to an own weight of the roll sheet Pr as well as can reduce the above described rotational resistance. As a result thereof, accurate conveyance can be realized. By providing the bearings 22 and 23 between the flange 24 and the rotation shaft 21R, the rotational resistance can be minimized. Further, since there is no clearance between the flange 24 and the rotation shaft 21R, center accuracy of the shaft of the roll sheet Pr can be achieved, and conveyance accuracy can be further improved.

This is described below in detail. FIG. 8 illustrates a lock free state (i.e., an open state) before the roll holder 20 is set. In FIG. 8, the lock lever 48 is pushed toward an open side by an acting force of the lever spring 50 (i.e., the spring). At the time, a protruding portion 48a of the lock lever 48 is brought into a state to close an opening portion of the guide slope 41 in a direction that the rotation shaft 21R is inserted.

When the rotation shaft 21R of the roll holder 20R is inserted, the rotation shaft 21R pushes the protruding portion 48a downwardly to cause the lock lever 48 to rotate. As a result thereof, the lock lever 48 is brought to the lock (close) state as illustrated in FIG. 9. At the time, the lock lever 48 is pushed by the acting force f of the lever spring 50 in a close direction, and a component force fa (i.e., a pushing force) is always applied to the rotation shaft 21R by a pushing surface 48b of the lock lever 48.

The component force fa and a component force wa in an insertion direction (extracting direction) of an own-weight reaction force w generated by the roll sheet having the heaviest weight at the U-shaped fitting portion 41b are set as follows.

fa>wa

Accordingly, the backlash of the rotation shaft 21R is eliminated and the rotation shaft 21R can be prevented from tilting, so that not only to alignment accuracy of the roll sheet Pr but also gear pitch accuracy when a rotary driving force is transmitted can be maintained. Thus, malfunctions such as gear scuffing and gear skipping are prevented from being generated. The lock lever 48 provided between the U-shaped fitting portions 41a and 41b enables the pushing force to act on both of the guide slopes. As a result thereof, an effect of suppressing the backlash can be effectively produced.

In the present exemplary embodiment, in order to suppress an adverse effect of the component force wa in the extracting direction of the own-weight reaction force due to the own-weight of the roll sheet W with the small component force (i.e., pushing force) fa, provided that a span between the U-shaped fitting portion 41a and the bearing 22 is set to L1 and a span between the U-shaped fitting portions 41a and 41b is set to L2 (see FIG. 3 or FIG. 7), L1 and L2 are set to have a following relationship.

L1≦L2

In the present exemplary embodiment, a weight of the roll sheet Pr is relatively small (i.e., equal to or less than 10 kg) and therefore, the own-weight reaction force w of the roll sheet Pr is small. Therefore, a locking mechanism is provided only to a right side (i.e., an R side) on which there is the driving force transmission mechanism provided. However, if the weight of the roll sheet Pr becomes larger due to a wider width or a larger diameter of the roll sheet Pr, the locking mechanism may also be provided at a slider side, as required.

In the present exemplary embodiment, an automatic lock opening and closing mechanism with a bi-stable spring is used as a locking mechanism in order to improve the operability. However, the locking mechanism may be configured such that a lock position and a free position are switched by clicking. Further, if the own-weight of the roll sheet Pr is small, or if a width of the roll sheet Pr is narrow, the lock lever 48 is not necessarily provided.

The configuration according to the present exemplary embodiment is applicable irrespective of a width or a diameter of the roll sheet Pr.

Further, since the present configuration is a setting method (i.e., a throw-in method) wherein locking of the rotation shaft 21R is completed only by inserting the roll sheet holding unit 20R into the bearing unit 40 of the main body, easy operation can be realized in installing the roll sheet Pr. Further, a removal operation of the roll sheet Pr can be performed with one action. Furthermore, in exchanging the roll sheet Pr having a size identical to the previous one, a slider operation of a side which receives the roll sheet holding unit 21L is not required, such that good exchange operability is realized.

Since a position with respect to the roll sheet Pr is not restricted in the configuration of the slider unit 30, the roll sheet in the recording apparatus can be freely layout.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-224829 filed Sep. 29, 2009, which is hereby incorporated by reference herein in its entirety.

What is claimed is:

1. A recording medium support apparatus for supporting a recording medium which is rolled into a roll shape around a core tube, the record medium support apparatus comprising:
a first fitting portion configured to be fitted to a first end portion of the core tube;
a second fitting portion configured to be fitted to a second end portion of the core tube;
a first rotation shaft configured to be supported by the first fitting portion via bearings such that the first rotation shaft can be rotated with respect to the first fitting portion;
a second rotation shaft configured to be supported by the second fitting portion via bearings such that the second rotation shaft can be rotated with respect to the second fitting portion; and
a supporting unit configured to support the first rotation shaft and the second rotation shaft.

2. The recording medium support apparatus according to claim 1, wherein the first fitting portion and the second fitting portion are respectively provided with ribs which contact a surface of an inner side of the core tube.

3. The recording medium support apparatus according to claim 1, wherein the first fitting portion and the second fitting portion are respectively provided with spring members which press-contact a surface of an inner side of the core tube.

4. The recording medium support apparatus according to claim 1, wherein each of the first fitting portion and the second fitting portion is provided with a flange which faces a corresponding end surface of the roll-shaped recording medium when the flange is fitted to the core tube, and wherein each of the first rotation shaft and the second rotation shaft is protruded from the corresponding flange on a side opposite to the corresponding fitting portion.

5. The recording medium support apparatus according to claim 4, wherein one of the flanges is provided with a rotation force transmission unit configured to transmit a driving force.

6. The recording medium support apparatus according to claim 1, wherein the supporting unit includes U-shaped grooves that support the respective first or second rotation shafts.

7. The recording medium support apparatus according to claim 6, further comprising a locking member configured to restrict each of the first and second rotation shafts at a position engaging with the U-shaped groove.

8. The recording medium support apparatus according to claim 7, wherein the locking member is rotatably supported so as to be movable between a restricted position for restricting each of the first and second rotation shafts at a position the first or second rotation shaft is engaged with the U-shaped groove and an open position for releasing the position of the first or second rotation shaft, and further comprising a spring which pushes the locking member in a direction to maintain the locking member at the restricted position and which pushes the locking member in a direction to maintain the locking member in the open position.

9. The recording medium support apparatus according to claim 8, wherein, if one of the first or second rotation shaft is thrown into the U-shaped groove when the locking member is in the open position, the locking member is pushed by the one of the first or second rotation shaft and moves to the restricted position.

10. A recording apparatus comprising:
the recording medium support apparatus according to claim 1;
a conveyance unit configured to convey a recording medium supported by the recording medium support apparatus; and
a recording unit configured to perform recording of an image onto the recording medium conveyed by the conveyance unit.
